(19) United States
(12) Patent Application Publication
(10) Pub. No.: US 2026/0172742 A1
(43) Pub. Date: Jun. 18, 2026

(54) EAR-WEARABLE ELECTRONIC DEVICE INCLUDING WIND NOISE FILTER

(71) Applicant: Starkey Laboratories, Inc., Eden Prairie, MN (US)

(72) Inventors: Viktor Klymko, Minneapolis, MN (US); Lillian Charlotte Kelly, Bloomington, MN (US)

(21) Appl. No.: 19/422,579

(22) Filed: Dec. 17, 2025

Related U.S. Application Data
(60) Provisional application No. 63/735,437, filed on Dec. 18, 2024.

(51) Int. Cl. H04R 1/28; H04R 1/08; H04R 25/00

(52) U.S. Cl. CPC H04R 1/2884; H04R 1/083; H04R 25/60; H04R 25/65; H04R 2410/07

(57) ABSTRACT

Various embodiments of an ear-wearable electronic device are disclosed. The device includes a housing, a microphone disposed within an interior volume of the housing, and an acoustic path disposed at least partially within the interior volume of the housing. The acoustic path includes a conduit extending along a conduit axis between a first end and a second end, a first acoustic port disposed at the first end of the conduit and acoustically coupled to a first opening defined by the outer surface of the housing, a second acoustic port disposed at the second end of the conduit and acoustically coupled to a second opening defined by the outer surface of the housing, and an outlet connected to the middle section of the conduit and that acoustically couples the acoustic path to an inlet of the microphone. The acoustic path can define a broadband wind noise filter.

This application claims the benefit of U.S. Provisional Application No. 63/735,437, filed Dec. 18, 2024, the disclosure of which is incorporated by reference herein in its entirety.

### BACKGROUND

Ear-wearable electronic devices such as hearing devices are disposed in an ear of a wearer or inserted into an opening of an ear canal of the wearer and typically include a housing or shell with electronic components such as a receiver (i.e., speaker) disposed within the housing. The receiver is adapted to provide acoustic information in the form of acoustic energy or waves to the wearer's ear canal from a controller either disposed within the housing of the hearing device or connected to the hearing device by a wired or wireless connection. This acoustic information can include music or speech from a recording or other source, e.g., ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

### SUMMARY

In general, the present disclosure provides various embodiments of an ear-wearable electronic device that includes one or more acoustic paths. The acoustic path can define a broadband wind noise filter that is configured to reduce wind noise that is detected by a microphone of the device. In one or more embodiments, the acoustic path can be disposed at least partially within a housing of the device and include a conduit that extends along a conduit axis, a first acoustic port disposed at a first end of the conduit, and a second acoustic port disposed at a second end of the conduit. The acoustic path can further include an outlet connected to a middle section of the conduit, where the outlet is configured to acoustically couple the acoustic path to an inlet of the microphone. In one or more embodiments, a portion of at least one of a first section of the conduit at the conduit's first end or the middle section includes a cross-sectional area in a cross-sectional plane that is orthogonal to the conduit axis that decreases in a direction from the first end of the conduit to the outlet along the conduit axis. In one or more embodiments, a portion of at least one of a second section of the conduit at the conduit's second end or the middle section includes a cross-sectional area in cross-sectional plane that decreases in a direction from the second end of the conduit to the outlet along the conduit axis.

In aspect, the present disclosure provides an ear-wearable electronic device that includes a housing having an outer surface and an inner surface that defines an interior volume of the housing, a microphone disposed within the interior volume of the housing and including an inlet, and an acoustic path disposed at least partially within the interior volume of the housing. The acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a first opening defined by the outer surface of the housing; and a second acoustic port disposed at the second end of the conduit and acoustically coupled to a second opening defined by the outer surface of the housing. The acoustic path further includes an outlet connected to the middle section of the conduit, where the outlet acoustically couples the acoustic path to the inlet of the microphone. A portion of at least one of the first section or middle section of the conduit includes a cross-sectional area in a cross-sectional plane that is orthogonal to the conduit axis that decreases in a direction from the first end of the conduit to the outlet along the conduit axis.

In another aspect, the present disclosure provides an acoustic path configured to be disposed at least partially within an interior volume of a housing of an ear-wearable device. The acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a first opening defined by an outer surface of the housing; and a second acoustic port disposed at the second end of the conduit and acoustically coupled to a second opening defined by the outer surface of the housing. The acoustic path further includes an outlet connected to the middle section of the conduit, where the outlet is configured to acoustically couple the acoustic path to an inlet of a microphone that is disposed within the interior volume of the housing of the device. A portion of the at least one of the first section or middle section of the conduit includes a cross-sectional area in a cross-sectional plane that is orthogonal to the conduit axis that decreases in a direction from the first end of the conduit to the outlet along the conduit axis.

In another aspect, the present disclosure provides a method of forming an ear-wearable electronic device, including disposing a microphone within an interior volume of a housing of the ear-wearable electronic device, where the interior volume is defined by an inner surface of the housing; and disposing an acoustic path at least partially within the interior volume of the housing. The acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a first opening defined by the outer surface of the housing; and a second acoustic port disposed at the second end of the conduit and acoustically coupled to a second opening defined by the outer surface of the housing. The acoustic path further includes an outlet connected to the middle section of the conduit. A portion of at least one of the first section or middle section of the conduit includes a cross-sectional area in a cross-sectional plane that is orthogonal to the conduit axis that decreases in a direction from the first end of the conduit to the outlet along the conduit axis. The method further includes acoustically coupling the microphone to the acoustic path via the outlet of the acoustic path.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device.

FIG. 2 is a schematic top view of a housing of the device of FIG. 1.

FIG. 3 is a schematic side cross-section view of a portion of the device of FIG. 1.

FIG. 4 is a schematic top cross-section view of a portion of the device of FIG. 1.

FIG. 5 is a schematic perspective view of a portion of the device of FIG. 1 with a portion of the housing removed for explanatory purposes.

FIG. 6 is a schematic cross-section view of a portion of the device of FIG. 1 with a microphone acoustically coupled to an acoustic path of the device.

FIG. 7 is a schematic front view of the acoustic path of FIG. 6.

FIG. 8 is a schematic top view of the acoustic path of FIG. 6.

FIG. 9 is a schematic bottom view of the acoustic path of FIG. 6.

FIG. 10 is a schematic front view of another embodiment of an acoustic path that can be utilized with the ear-wearable electronic device of FIG. 1.

FIG. 11 is a schematic top view of another embodiment of an acoustic path that can be utilized with the ear-wearable electronic device of FIG. 1.

FIG. 12 is a graph of normalized sound pressure level (dB) versus time (ms) for a modeled reference acoustic path and one embodiment of an acoustic path of an ear-wearable electronic device.

FIG. 13 is a flowchart of one technique for forming the ear-wearable electronic device of FIG. 1.

FIG. 14 is a diagram of another embodiment of an ear-wearable electronic device.

### DETAILED DESCRIPTION

In general, the present disclosure provides various embodiments of an ear-wearable electronic device that includes one or more acoustic paths. The acoustic path can define a broadband wind noise filter that is configured to reduce wind noise that is detected by a microphone of the device. In one or more embodiments, the acoustic path can be disposed at least partially within a housing of the device and include a conduit that extends along a conduit axis, a first acoustic port disposed at a first end of the conduit, and a second acoustic port disposed at a second end of the conduit. The acoustic path can further include an outlet connected to a middle section of the conduit, where the outlet is configured to acoustically couple the acoustic path to an inlet of the microphone. In one or more embodiments, a portion of at least one of a first section of the conduit at the conduit's first end or the middle section includes a cross-sectional area in a cross-sectional plane that is orthogonal to the conduit axis that decreases in a direction from the first end of the conduit to the outlet along the conduit axis. In one or more embodiments, a portion of at least one of a second section of the conduit at the conduit's second end or the middle section includes a cross-sectional area in cross-sectional plane that decreases in a direction from the second end of the conduit to the outlet along the conduit axis.

Currently-available ear-wearable electronic devices such as hearing devices can be exposed to elements of an external environment of a wearer of the device, specifically wind. Such wind can gust, causing pressure variations in an acoustic path of the device that acoustically couples the external environment to a microphone disposed within the device, which can detect wind noise caused by such gusts. This wind noise can interfere with signals produced by the microphone that are directed to the wearer via a speaker or receiver of the device, thereby reducing a signal to noise ratio of such signals and also reducing speech intelligibility and listening comfort of the wearer.

One or more embodiments of ear-wearable electronic devices described herein can provide various advantages over these currently-available devices. For example, the acoustic path of the ear-wearable electronic device can be configured as a broadband wind noise filter that can reduce wind noise in the acoustic energy received by the microphone. As used herein, the term “broadband wind noise filter” means a filter that is configured to filter a portion of a wind frequency range of interest and has a bandwidth that is significant compared to its central target frequency. For example, typical wind energy frequencies are concentrated below 2 kHz. In one or more embodiments, a broadband wind noise filter will have a bandwidth of about 2 kHz and a center frequency of about 1 kHz. In one or more embodiments, the acoustic path can be configured to reduce a sound pressure level of the wind noise received by the microphone by at least 2 dB. In one or more embodiments, the acoustic path can be configured to reduce the sound pressure level of the wind noise received by the microphone by at least 5 dB.

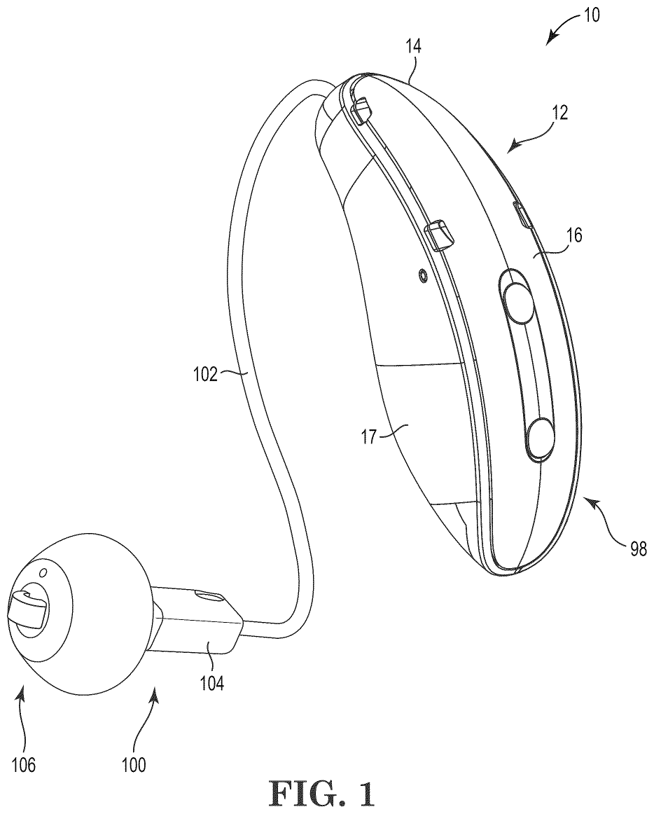

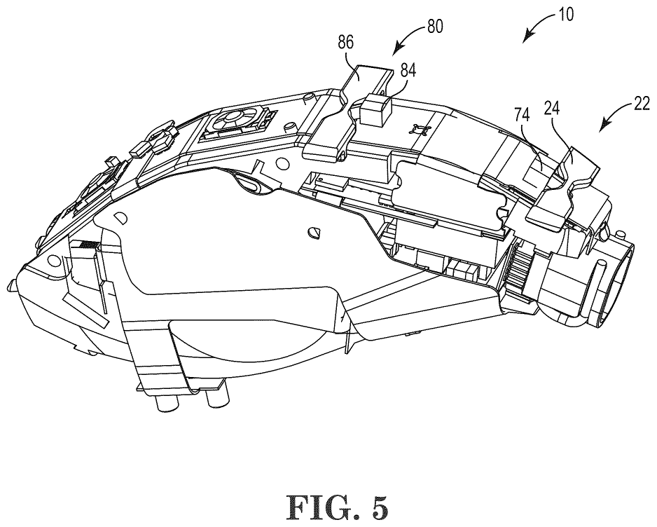

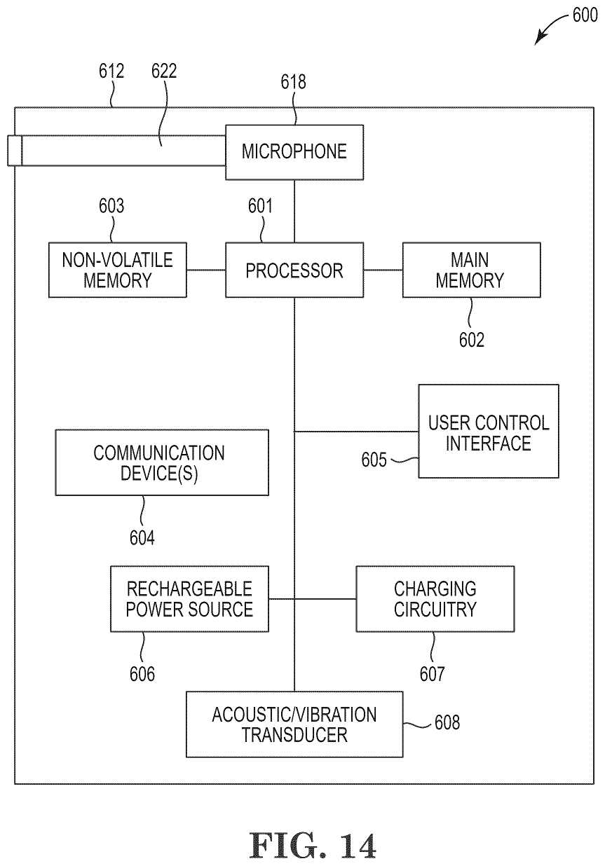

FIGS. 1-6 are various views of one embodiment of an ear-wearable electronic device 10. The device 10 is a behind-the-ear (BTE) type device and thus includes a housing 12 that is operable to be worn on or behind an ear of a wearer. The device 10 can include any suitable electronic circuitry or components, e.g., the electronic circuitry and components of ear-wearable electronic device 600 of FIG. 14.

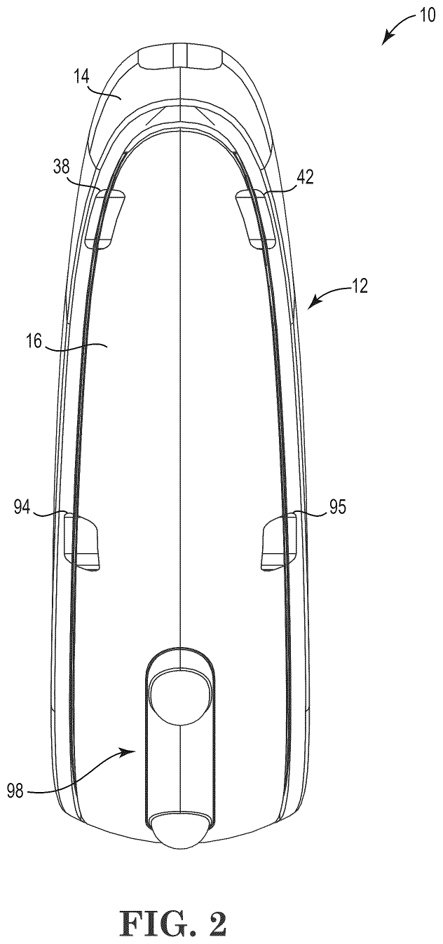

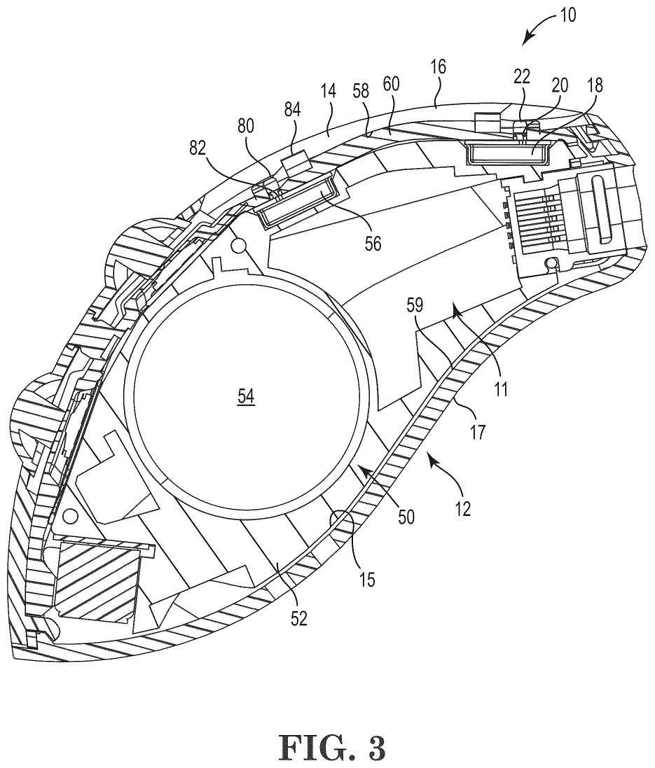

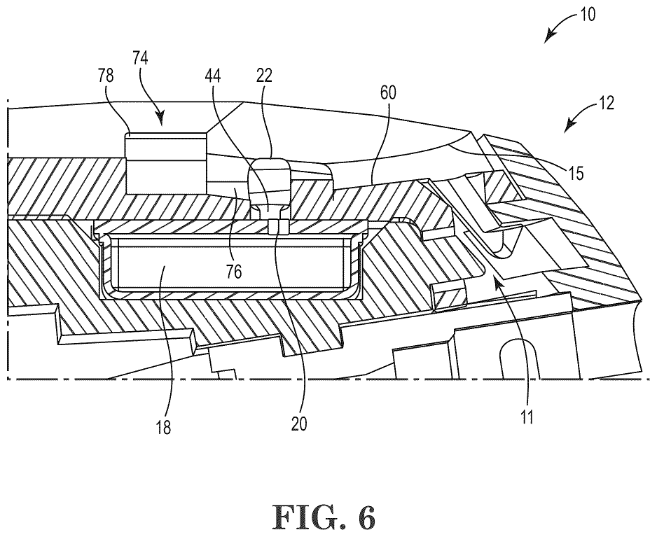

The housing 12 includes an outer surface 14 and an inner surface 15 (FIG. 3). The inner surface 15 of the housing 12 defines an interior volume 11 of the housing. As shown in FIGS. 3 and 6, which are schematic cross-section views of a portion of the device 10, a microphone 18 is disposed within the interior volume 11 of the housing 12 and includes an inlet 20. An acoustic path 22 (FIGS. 3-9) is disposed at least partially within the interior volume 11 of the housing 12. The acoustic path 22 includes a conduit 24 extending along a conduit axis 2 between a first end 26 and a second end 28. As shown in FIG. 8, which is a schematic plan view, the conduit 24 includes a first section 30 at the first end 26, a second section 32 at the second end 28, and a middle section 34 disposed between the first section and the second section. The conduit 24 further includes a first acoustic port 36 disposed at the first end 26 of the conduit 24 and acoustically coupled to a first opening 38 (FIG. 2) defined by the outer surface 14 of the housing 12, a second acoustic port 40 disposed at the second end 28 of the conduit and acoustically coupled to a second opening 42 defined by the outer surface of the housing, and an outlet 44 (FIG. 9) connected to the middle section 34 of the conduit. As used herein, the term “acoustically coupled” means fluidically coupled or that any barrier positioned between two or more elements or components that are acoustically coupled is generally acoustically transparent for frequencies of interest, where acoustically transparent means that the element or component attenuates sound at a sound pressure level of no greater than 6 dB. The outlet 44 acoustically couples the acoustic path 22 to the inlet 20 of the microphone 18 as shown in FIG. 6. In one or more embodiments, a portion 31 (FIG. 8) of at least one of the first section 30 or middle section 34 of the conduit 24 includes a cross-sectional area in a cross-sectional plane that is orthogonal to the conduit axis 2 that decreases in a direction from the first end 26 of the conduit to the outlet 44 along the conduit axis. As used herein, the phrase “cross-sectional area” means a cross-sectional rea of an interior volume or space within the conduit 24 that is defined by an inner surface (e.g., inner surface 66 of FIG. 8) of the conduit.

The housing 12 of the device 10 can take any suitable shape and having any suitable dimensions. In one or more embodiments, the housing 12 is configured to rest against a wearer's outer ear in a behind-the-ear orientation. The housing 12 can be manufactured by, for example, injection-molding, 3D printing, etc. The housing 12 can also include any suitable materials, e.g., inorganic (e.g., metallic, ceramic) or organic (e.g., polymeric) materials. In one or more embodiments, the housing 12 can include at least one of silicone, urethane, acrylate, flexible epoxy, or acrylated urethane.

The housing 12 can be a single, integral housing or two or more portions that are connected using any suitable technique. In the illustrated embodiment, the housing 12 includes a top shell 16 and the bottom shell 17. For purposes of this disclosure, the terms “top,” “bottom,” “above,” “below,” “front,” “back,” etc. are not intended to indicate a required orientation of use relative to the ground or other reference point. Generally, these terms are intended to help distinguish locations relative to an arbitrary reference point and may correspond to the orientation in the drawings, but no limitation is intended by the use of these terms.

The top shell 16 can be connected to the bottom shell 17 using any suitable technique. In one or more embodiments, the top shell 16 can be removably connected to the bottom shell 17 using any suitable technique, e.g., adhering, snap fitting, press fitting, mechanically fastening, welding, etc.

The top and bottom shells 16, 17 form the interior volume 11 that is defined by the inner surface 15 of the housing 12 and that, once assembled, holds electronic components 50. For example, the device 10 includes the microphone 18 disposed within any suitable portion of the interior volume 11 of the housing 12. In one or more embodiments, the microphone 18 can be disposed on a frame 52 that is disposed within the housing 12 between the top shell 16 and the bottom shell 17. The frame 52 can take any suitable shape and have any suitable dimensions. Further, the frame 52 can be configured to support other electronic components such as battery 54.

The microphone 18 includes the inlet 20. Further, the microphone 18 can include any suitable microphone, e.g., a MEMS microphone, an electret condenser microphone, co-joined microphone sets, etc. The device 10 can include any suitable number of microphones. In one or more embodiments, the device 10 includes a second microphone 56 as is further described herein. The microphone 18 can be configured to convert acoustic energy (e.g., acoustic waves) that enter the microphone through its inlet 20 into one or more electric signals that are directed to a controller or processor (e.g., processor 601 of ear-wearable electronic device 600 of FIG. 14) disposed within the housing 12 or remotely from the housing by a wired or wireless connection.

Disposed at least partially within the interior volume 11 of the housing 12 is the acoustic path 22. In one or more embodiments, the acoustic path 22 can be disposed entirely within the housing 12. In one or more embodiments, the acoustic path 22 can be disposed at least partially within an inner surface 58 of the top shell 16, where such inner surface in part defines the inner surface 15 of the housing. In one or more embodiments, the acoustic path 22 can be disposed at least partially within an inner surface 59 of the bottom shell 17. The gasket 60 can take any suitable shape and have any suitable dimensions. The gasket 60 can be a single continuous piece or multiple pieces. Further, the gasket 60 can include any suitable material, e.g., at least one of an inorganic (e.g., metallic, ceramic) material or an organic (e.g., polymeric) material. Further, in one or more embodiments, the gasket 60 can be sealed to the inner surface 58 of the top shell 16 such that that acoustic path 22 is entirely enclosed by the top shell and the gasket.

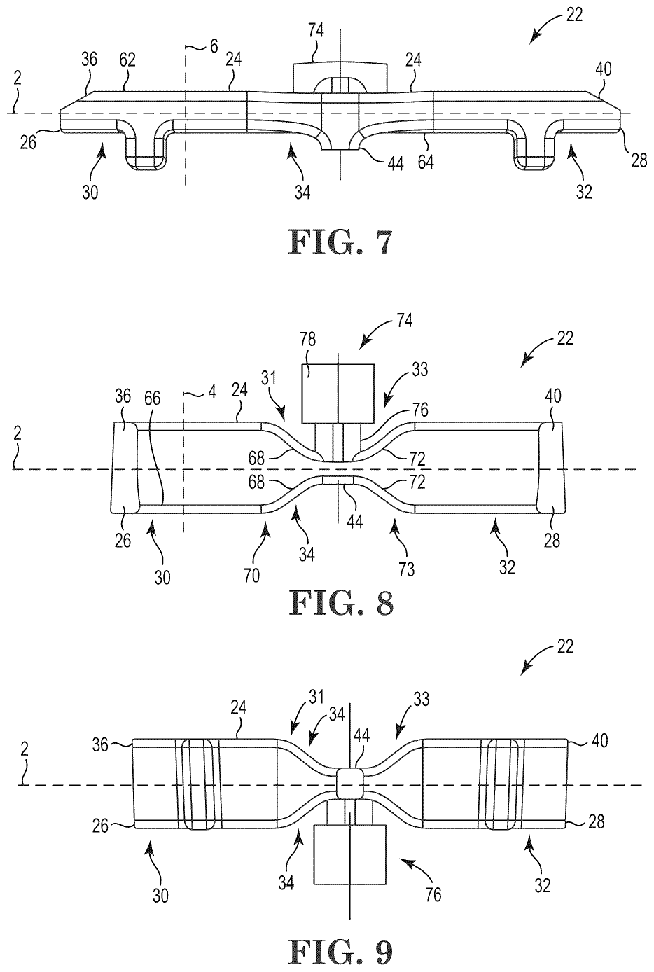

As can be seen, e.g., in FIGS. 7-9, the acoustic path 22 includes the conduit 24 that extends along the conduit axis 2 between the first end 26 and the second end 28 of the conduit. The conduit 24 can take any suitable shape and have any suitable dimensions. The conduit 24 includes the first section 30 that is at or adjacent the first end 26 of the conduit, the second section 32 that is at or adjacent the second end 28 of the conduit, and the middle section 34 disposed between the first section and the second section. The first section 30 and the second section 32 can each take any suitable shape and have any suitable dimensions. In one or more embodiments, the first section 30 takes the same shape as the second section 32. Further, in one or more embodiments, the first section 30 can take a shape that is different from a shape of the second section 32. The first and second sections 30, 32 can have the same or different dimensions. In one or more embodiments, the conduit 24 is symmetrical about an axis that intersects the outlet 44 and is orthogonal to the conduit axis 2.

The acoustic path 22 can include one or more portions having differing cross-sectional areas or dimensions than one or more additional portions of the path. For example, as shown in FIG. 8, the acoustic path 22 is configured so that a portion 31 of at least one of the first section 30 or middle section 34 of the conduit 24 includes a cross-sectional area in a cross-sectional plane that is orthogonal to the conduit axis 2 that decreases in a direction from the first end 26 of the conduit to the outlet 44 along the conduit axis (i.e., in a direction from left to right in FIG. 8). Such decreasing portion 31 can be disposed in the first section 30, the middle section 34, or in both the first section and middle section. In one or more embodiments, the decreasing portion 31 can be a transition between the first section 30 and the middle section 34. As shown in FIG. 8, the decreasing portion 31 is disposed in the middle section 34. In one or more embodiments, where the decreasing portion 31 is disposed in the middle section 34, the first section 30 can have a substantially constant cross-sectional area along the conduit axis 2 as shown in FIG. 8.

In one or more embodiments, the cross-sectional area of the conduit 24 can also decrease in a direction from the second end 28 of the conduit to the outlet 44 along the conduit axis 2 (i.e., from right to left in FIG. 8). As shown in FIG. 8, a portion 33 of at least one of the second section 32 or the middle section 34 of the conduit 24 can include a cross-sectional area in the cross-sectional plane that decreases in a direction from the second end 28 of the conduit to the outlet 44 along the conduit axis 2. Such decreasing portion 33 can be disposed in the second section 32, the middle section 34, or in both the second section and middle section. In one or more embodiments, the decreasing portion 33 can be a transition between the second section 32 and the middle section 34. As shown in FIG. 8, the decreasing portion 33 is disposed in the middle section 34. In one or more embodiments, this decreasing portion 33 along with the decreasing portion 31 define a venturi in the middle section 34 that is centered at the outlet 44. In one or more embodiments, where the decreasing portion 33 is disposed in the middle section 34, the second section 32 can have a substantially constant cross-sectional area along the conduit axis 2 as shown in FIG. 8.

The conduit 24 can include any suitable number of portions that exhibit increasing or decreasing cross-sectional area. Further, the conduit 24 can include any suitable structure to provide increasing or decreasing cross-sectional portions. For example, as shown in FIG. 7, the conduit 24 can include a top surface 62 and a bottom surface 64. The outlet 44 of the acoustic path 22 is connected to the bottom surface 64. The top surface 62 and the bottom surface 64 can each take any suitable shape. In one or more embodiments, the top surface 62 is substantially parallel to the bottom surface 64 as shown in FIG. 7. A length of the conduit 24 can be measured in a direction along the conduit axis 2, a width of the conduit 24 can be measured in a direction along a first transverse axis 4 (FIG. 8) that is orthogonal to the conduit axis and along with the conduit axis defines a plane that is parallel to a portion of the top surface 62 of the first section 30 of the conduit at the first end 26 of the conduit. Further, a height of the conduit can be measured in a direction along a second transverse axis 6 (FIG. 7) that is orthogonal to the conduit axis 2 and the first transverse axis 4.

As shown in FIG. 8, a width of the middle section 34 of the conduit 24 as measured along the first transverse axis 4 decreases in the direction from the first end 26 to the outlet 44 of the acoustic path 22. Further, a width of the middle section 34 of the conduit 24 decreases in the direction from the second end 28 to the outlet 44 of the acoustic path 22. In one or more embodiments, a width of at least one of the first section 30 or second section 32 can decrease in the direction from the first end 26 or the second end 28 respectively to the outlet 44 of the acoustic path 22. In one or more embodiments, a width of at least a portion of the first section 30 and the middle section 34 decreases in the direction from the first end 26 of the conduit 24 to the outlet 44 of the acoustic path 22. Further, in one or more embodiments, a width of at least a portion of the second section 32 and the middle section 34 decreases in the direction from the second end 28 of the conduit 24 to the outlet 44 of the acoustic path 22.

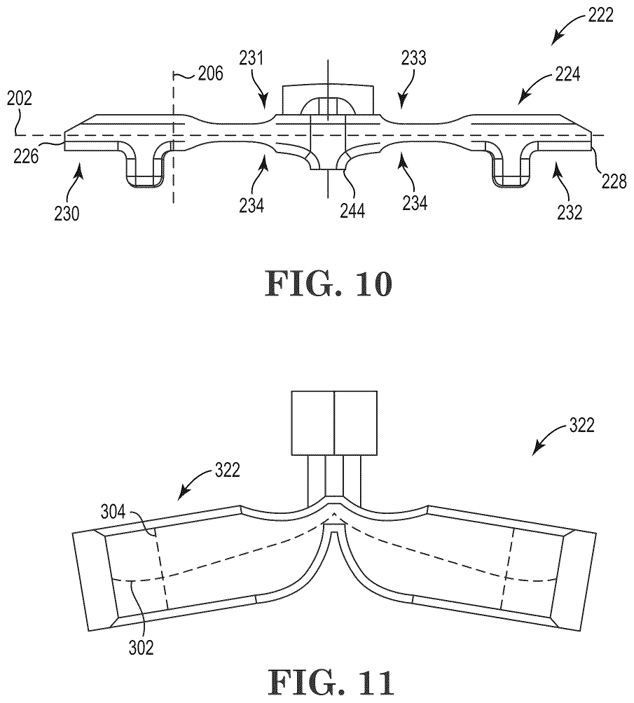

In one or more embodiments, changes in the cross-sectional area of the conduit 24 can be provided by a change in height of the conduit along the second transverse axis 6. For example, FIG. 10 is a schematic cross-section view of another embodiment of an acoustic path 222. All design considerations and possibilities described herein regarding the acoustic path 22 of FIGS. 3-9 apply equally to acoustic path 222 of FIG. 10 unless stated otherwise. One difference between acoustic path 222 of FIG. 10 and acoustic path 22 FIGS. 3-9 is that a height of at least one of a first section 230 or a middle section 234 of the conduit 224 as measured along a second transverse axis 206 that is orthogonal to a conduit axis 202 and a first transverse axis (e.g., transverse axis 4 of FIG. 8) decreases in a direction from a first end 226 of the conduit to an outlet 244 of the acoustic path in a portion 231 of the conduit. Further, a height of at least one of a second section 232 or the middle section 234 of the conduit 224 decreases in a direction from a second end 228 of the conduit to the outlet 244 of the acoustic path 222 to provide a reduced or decreasing portion 233. As a result, a decreasing cross-sectional area can be provided by change in height of the conduit 224. In one or more embodiments, a change in cross-sectional area of the conduit 24 of FIGS. 3-9 or conduit 224 of FIG. 10 can be provided by a change in width and a change in height of one or more portions of the conduit.

Returning to FIGS. 3-9, a cross-sectional area of each of the first section 30 and the second section 32 can have any suitable relationship with a cross-sectional area of the middle section 34. For example, in one or more embodiments, the smallest cross-sectional area of the middle section 34 of the conduit 24 can be no greater than one half of a greatest cross-sectional area of the first section 30 of the conduit at the first end 26 of the conduit. Further, for example, a smallest cross-sectional area of the middle section 34 of the conduit 24 can be no greater than one half of a greatest cross-sectional area of the second section 32 of the conduit at the second end 28 of the conduit. In general, the cross-sectional area of any section of the conduit 24 can have any suitable value. For example, a cross-sectional area of at least one of the first section 30 or the second section 34 of the conduit 24 can be no greater than 0.8 mm\hat{ }2. Further, in one or more embodiments, the cross-sectional area of the middle section 34 of the conduit 24 can be no greater than 0.25 mm\hat{ }2.

As mentioned herein, the conduit 24 can include one or more curve portions that can define a transition region of the conduit between at least one of the first section 30 or second section 32 and the middle section 34, where the one or more curve portions provide a selected change in cross-sectional area. For example, as shown in FIG. 8, the inner surface 66 of the conduit 24 includes one or more curve portions 68. The curve portions 68 can define a transition region 70 of the conduit 24 between the first section 30 and the middle section 34. Also, the inner surface 66 of the conduit 24 can include one or more curve portions 72 that define a transition region 73 of the conduit between the second section 32 and the middle section 34. The curve portions 68, 72 can take any suitable curved shape and have any suitable dimensions. Further, the curved portions 68, 72 can lie in any suitable plane, e.g., in the plane defined by the conduit axis 2 and the first transverse axis 4, in the plane defined by the conduit axis 2 and the second transverse axis 6, in the plane defined by the first transverse axis and the second transverse axis, or in multiple planes.

As also mentioned herein, the first acoustic port 36 of the acoustic path 22 can be acoustically coupled to the first opening 38 defined by the outer surface 14 of the housing 12 using any suitable technique. Further, the second acoustic port 40 can be acoustically coupled to the second opening 42 that is defined by the outer surface 14 of the housing 12 using any suitable technique. The first and second acoustic ports 36, 40 can take any suitable shape and have any suitable dimensions. Further, each of the first and second acoustic ports 36, 40 can be configured to receive acoustic energy from the external environment and direct such energy into the acoustic path 22.

In general, the acoustic path 22 can define a broadband wind noise filter. When the wind passes through the conduit, it passes through a portion (e.g., portion 31 or portion 33) that has a smaller cross-sectional area, which causes air pressure of the wind to decrease (i.e., caused by the Bernoulli effect). Such air pressure drop is broadband and will mostly occur at low frequencies carried by the wind. For example, the air pressure drop can be in a range of 0 kHz to about 2 kHz. The narrowed conduit 24 at these decreasing portions can reduce the wind pressure perceived by the microphone 18, thereby resulting in lower noise perceived by the microphone.

The acoustic path 22 further includes the outlet 44 (FIGS. 7 and 9) connected to the middle section 34 of the conduit 24. The outlet 44 acoustically couples the acoustic path 22 to the inlet 20 of the microphone 18 using any suitable technique. In one or more embodiments, the inlet 20 of the microphone 18 can be disposed within the outlet 44 of the acoustic path 22. The outlet 44 can take any suitable shape and have any suitable dimensions.

As mentioned herein, the acoustic path 22 can take any suitable shape. For example, the acoustic path 22 can be curved in at least one of the plane defined by the conduit axis 2 and the first transverse axis 4 or the plane defined by the conduit axis and the second transverse axis 6. For example, FIG. 11 is a schematic cross-section view of another embodiment of an acoustic path 322. All design considerations and possibilities described herein regarding acoustic path 22 of FIGS. 3-9 apply equally to acoustic path 322 of FIG. 11 unless stated otherwise. As shown in FIG. 11, the acoustic path 322 extends along a conduit axis 302 that is curved in a plane defined by the conduit axis and a transverse axis 304. The conduit axis 302 can be curved in any suitable plane or planes of the acoustic path 322.

Returning to FIGS. 3-9, the device 10 further includes an acoustic filter 74, which is disposed at least partially within the interior volume 11 of the housing 12. The device 10 can include any suitable acoustic filter, e.g., one or more embodiments of acoustic filters described in U.S. Provisional Ser. No. 63/555,212, to Klymko et al., and entitled EAR-WEARABLE ELECTRONIC DEVICE INCLUDING ACOUSTIC FILTER. The acoustic filter 74 includes a neck 76 and a resonance cavity 78 acoustically coupled to the neck.

The acoustic filter 74 is acoustically coupled to the acoustic path 22 via the neck 76 using any suitable technique. Further, the acoustic filter 74 is configured to reduce an intensity of acoustic energy sensed by the microphone 18 in any suitable frequency range.

The neck 76 of the acoustic filter 74 can take any suitable shape and have any suitable dimensions. The resonance cavity 78 of the acoustic filter 74 can also take any suitable shape and have any suitable dimensions. The cavity 78 can have a resonant frequency in a selected frequency range. In one or more embodiments, this frequency range can include ultrasonic frequencies. In one or more embodiments, the frequency range includes frequencies of at least 20 kHz and no greater than 50 kHz. Further, in one or more embodiments, the frequency range can include frequencies of at least 25 kHz and no greater than 40 kHz. In one or more embodiments, the dimensions of the cavity 78 can be selected so that the acoustic filter 74 reduces microphone sensitivity at the resonant frequency of the cavity.

While not wishing to be bound by any particular theory, the broadband wind noise filter defined by the acoustic path 22 is configured to filter pressure generated by air flow through the acoustic path, while the acoustic filter 74 is configured to filter standing acoustic waves that are present in the acoustic path. While the acoustic path 22 is, therefore, configured to reduce the pressure of the air flowing therethrough and, as a result, reduce pressure exerted on the microphone 18 caused by wind noise that enters the acoustic path, the acoustic filter 74 is configured to absorb acoustic energy of the standing acoustic waves to reduce ultrasonic acoustic energy that is sensed by the microphone 18, also reducing pressure exerted on the microphone.

As mentioned herein, the ear-wearable electronic device 10 can include any suitable number of microphones. For example, as shown in FIG. 3, the device 10 includes a second microphone 56 disposed within the interior volume 11 of the housing 12. In such embodiments, the microphone 18 can be considered to be a first microphone. The device 10 can further include a second acoustic path 80 acoustically coupled to the second microphone 56, and a second acoustic filter 84 acoustically coupled to the second acoustic path. In such embodiments, the acoustic path 22 can be considered to be a first acoustic path, and the acoustic filter 74 can be considered to be a first acoustic filter. All design considerations and possibilities described herein regarding the first microphone 18, the first acoustic path 22, and the first acoustic filter 74 apply equally to the second microphone 56 and its associated second acoustic path 80 and second acoustic filter 84.

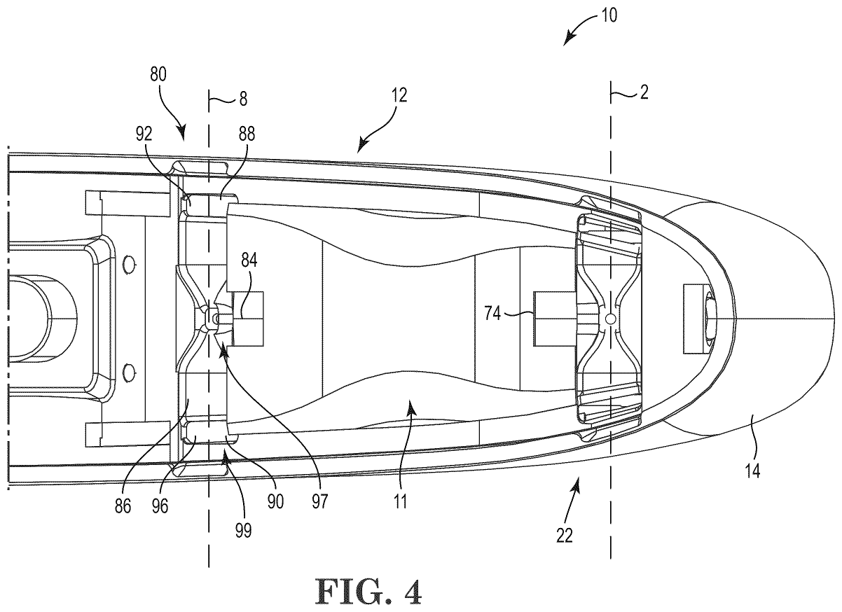

The second microphone 56 includes an inlet 82. Further, the device 10 includes the second acoustic path 80 disposed at least partially within the interior volume 11 of the housing 12. As shown in FIG. 4, the second acoustic path 80 includes a conduit 86 extending along a conduit axis 8 between a first end 88 and a second end 90. The second acoustic path 80 also includes a first acoustic port 92 disposed at or adjacent to the first end 88 of the conduit 86 and acoustically coupled to a third opening 94 (FIG. 2) defined by the outer surface 14 of the housing 12, a second acoustic port 96 disposed at or adjacent to the second end 99 of the conduit and acoustically coupled to a fourth opening 95 defined by the outer surface of the housing, and an outlet 97 connected to the conduit. The second acoustic path 80 can include any suitable acoustic path, e.g., acoustic path 22. For example, the second acoustic path 80 can be configured so that at least one of a first section or middle section of the conduit includes a cross-sectional area in a cross-sectional plane that is orthogonal to the conduit axis 8 that decreases in a direction from the first end 88 of the conduit 86 to the outlet 97 along the conduit axis 8.

The device 10 can also include the second acoustic filter 84 disposed at least partially within the interior volume 11 of the housing 12. The second acoustic filter 84 can include any suitable acoustic filter, e.g., acoustic filter 74. The second acoustic filter 84 can be acoustically coupled to the second acoustic path 80 using any suitable technique.

Although the embodiment of the device 10 of FIGS. 1-9 includes a single acoustic filter 74, 84 acoustically coupled to each acoustic path 22, 80, in one or more embodiments, each acoustic path can include two or more acoustic filters that are acoustically coupled to the respective acoustic path using any suitable technique. In such embodiments, each acoustic filter acoustically coupled to an acoustic path can be configured to reduce an intensity of acoustic energy sensed by the associated microphone in a selected frequency range. For example, a first acoustic filter connected to the acoustic path can be configured to reduce an intensity of acoustic waves sensed by the associate microphone in a first frequency range, and a second acoustic filter acoustically connected to the acoustic path can be configured to reduce an intensity of acoustic waves sensed by the associated microphone in a second frequency range that is different from the first frequency range. In such embodiments, each acoustic filter can be configured to be a stop band filter that is configured to reduce the intensity of the acoustic waves sensed by the associated microphone in any desirable frequency range.

Returning to FIGS. 1-2, the ear-wearable device 10 can include one or more user input devices 98. In the illustrated embodiment, the user input devices 98 are disposed on the top shell 16 of the housing 12, but other placements of the user input devices are possible. The user input devices 98 may include buttons, switches, or the like, such as a first button and a second button. The user can interact with the user input devices 98 (e.g., by pressing one or more buttons) to adjust the volume, change one or more settings, or turn the ear-wearable electronic device 10 on or off.

The device 10 can also include an earpiece 100 that is coupled to the housing 12 by a cable 102. The earpiece 100 can include an earpiece housing 104 and a receiver (e.g., acoustic/vibration transducer 608 of FIG. 14) disposed at least partially within the earpiece housing. The receiver is configured to direct acoustic waves into the wearer's ear through a receiver path that extends between an outlet 106 disposed at an outer surface of the earpiece housing 104 and an inlet (not shown) disposed within the earpiece housing that is acoustically coupled to the receiver. This configuration is referred to as receiver-in-canal (RIC). Note that the features described herein, while shown implemented in a RIC device, are applicable to other configurations, such as in-the-canal (ITC) types of devices, in which the receiver is integrated into a housing that fits in the ear canal. In such device, the housing (which holds at least one externally-facing microphone) may be hidden in the canal or housing or have a visible part in the outer ear extending from the ear canal.

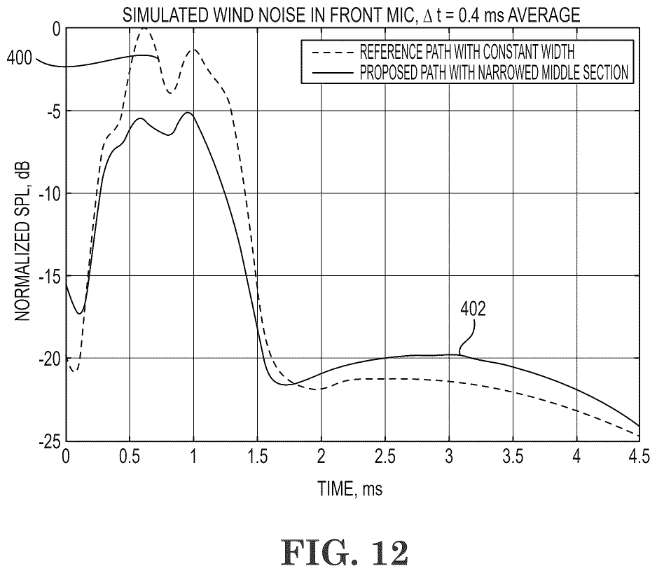

In general, the various embodiments of the acoustic paths described herein can include any suitable structure or features such that the acoustic path can define a broadband wind noise filter that can be configured to reduce wind noise in acoustic energy that reaches a microphone of an ear wearable electronic device. For example, FIG. 12 is a graph of normalized sound pressure level (dB) versus time (milliseconds) for a modelled reference acoustic path that has a constant cross-sectional area along the path (curve 400) and a modelled acoustic path that has a cross-sectional area that decreases in a middle section of the path (curve 402) (e.g., acoustic path 22). A pressure in a front volume of a Sonion P8 MEMS microphone (available from Sonion, Roskilde Denmark) attached to a reference acoustic path that has a constant cross-sectional area was simulated. Further, the front volume of the Sonion microphone was attached to an acoustic path having the cross-sectional area that decreases toward the middle section of the path, i.e., acoustic path 22 of FIGS. 3-9. In the simulation, a finite element model for fluid dynamics physics was used, where a hearing aid case with microphone paths as stated herein is exposed to a gust of wind. The wind speed quickly rises to 3 m/s, and then falls when gusts arrive at a 20 degree angle to a conduit axis of the conduit of the acoustic path. This fluid profile is widely used in the industry and referred to as a von Kaiman model.

The peak level wind noise as shown in the graph is 5 dB lower than the reference acoustic path when utilizing an acoustic path that is similar to the acoustic path 22 of FIGS. 3-9. This decrease in wind noise would be noticeable by wearer and would improve a signal-to-noise ratio of the device 10.

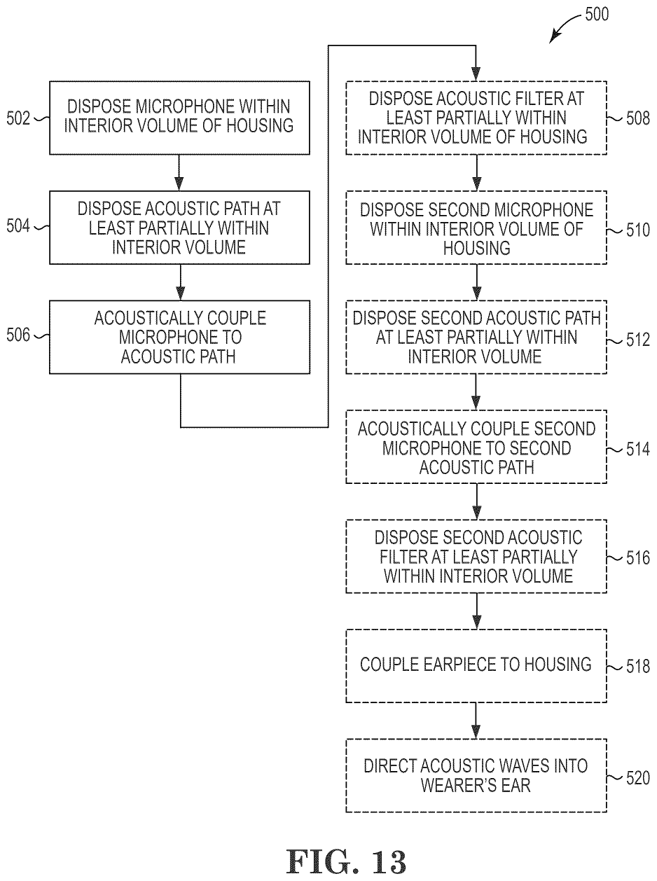

Any suitable technique can be utilized to form the various embodiments of ear-wearable electronic devices. For example, FIG. 13 is a flowchart of one embodiment of a technique 500 for forming the ear-wearable electronic device 10. Although described regarding ear-wearable electronic device 10 of FIGS. 1-9, the technique 500 can be utilized to form any suitable ear-wearable electronic device. At 502, the microphone 18 is disposed within the interior volume 11 of the housing 12 of the device 10. Further, the acoustic path 22 can be disposed at least partially within the interior volume 11 of the housing 12 at 504 using any suitable technique. The microphone 18 can be acoustically coupled to the acoustic path 22 at 506 using any suitable technique. At 508, the acoustic filter 74 can optionally be disposed at least partially within the interior volume 11 of the housing 12 using any suitable technique. Further, the acoustic filter 74 can be acoustically coupled to the acoustic path 22 via the neck 76.

At 510, the second microphone 56 can optionally be disposed within the interior volume 11 of the housing, and the second acoustic path 80 can also be disposed at least partially within the interior volume at 512 using any suitable technique. At 514, the second microphone 56 can optionally be acoustically coupled to the second acoustic path 80 using any suitable technique. Further, the second acoustic filter 84 can optionally be disposed at least partially within the interior volume 11 and acoustically coupled to the acoustic path 80 at 516 using any suitable technique. At 518, the earpiece 100 can optionally be coupled to the housing 12 using any suitable technique, e.g., the cable 102 can be utilized to couple the earpiece to the housing. Acoustic waves or energy can be directed into the wearer's ear at 520 using any suitable technique.

The various embodiments of ear-wearable devices described herein can include any suitable electronic components or circuitry. For example, FIG. 14 is a block diagram that illustrates one embodiment of a system and ear-wearable electronic device 600 in accordance with any of the embodiments disclosed herein. The device 600 includes a housing 612 configured to be worn in, on, or about an ear of a wearer. The device 600 shown in FIG. 14 can represent a single hearing device configured for monaural or single-ear operation or one of a pair of hearing devices configured for binaural or dual-ear operation. Various components are situated or supported within or on the housing 612. The housing 612 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The device 600 includes a processor 601 operatively coupled to a main memory 602 and a non-volatile memory 603. The processor 601 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 601 can include or be operatively coupled to main memory 602, such as RAM (e.g., DRAM, SRAM). The processor 601 can include or be operatively coupled to non-volatile (persistent) memory 603, such as ROM, EPROM, EEPROM or flash memory.

The device 600 includes an audio processing facility operably coupled to, or incorporating, the processor 601. The audio processing facility includes audio signal processing circuitry (e.g., analog front-end, analog-to-digital converter, digital-to-analog converter, DSP, and various analog and digital filters), a microphone arrangement 618, and an acoustic/vibration transducer 608 (e.g., loudspeaker, receiver, bone conduction transducer, motor actuator). The acoustic transducer 608 produces amplified sound inside of the ear canal. The microphone arrangement 618 can include one or more discrete microphones or a microphone array(s) (e.g., configured for microphone array beamforming). Each of the microphones of the microphone arrangement 618 can be situated at different locations of the housing 612. It is understood that the term microphone used herein can refer to a single microphone or multiple microphones unless specified otherwise. The microphone 618 is operatively coupled to the processor 601 and is configured to direct a microphone signal to the processor, which in turn directs a receiver signal to the transducer 608 that is based at least in part on the microphone signal.

At least one of the microphones 618 may be configured as a reference microphone producing a reference signal in response to external sound outside an ear canal of a user. Generally, at least one the reference microphones 618 (also referred to as an externally facing microphones) is acoustically coupled to ambient air outside the housing 612 via an acoustic path 622 and an opening defined by the housing. The acoustic path allows air to pass between two parts of the housing 612 or may be formed within one part of the housing.

The device 600 may also include a user control interface 605 operatively coupled to the processor 601. The user control interface 605 is configured to receive an input from the wearer of the device 600. The input from the wearer can be any type of user input, such as a touch input, a gesture input, or a voice input. The user control interface 605 may be configured to receive an input from the wearer of the device 600.

The device 600 can include one or more communication device 604. For example, the one or more communication device 604 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 600 can include a near-field magnetic induction (NFMI) sensor (e.g., an NFMI transceiver coupled to a magnetic antenna) for effecting short-range communications (e.g., ear-to-ear communications, ear-to-kiosk communications). The communication device 604 may also include wired communications, e.g., universal serial bus (USB) and the like.

The device 600 also includes a power source 606, which can be a conventional battery, a rechargeable battery (e.g., a lithium-ion battery), or a power source including a supercapacitor. In the embodiment shown in FIG. 17, the device 600 includes a rechargeable power source 606 that is operably coupled to power management circuitry 607 for supplying power to various components of the device 600. The rechargeable power source 606 is coupled to charging circuity 607. The charging circuitry 607 is, for example, electrically coupled to charging contacts on the housing 612 that are configured to electrically couple to corresponding charging contacts of a charging unit when the device 600 is placed in the charging unit.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An ear-wearable electronic device that includes a housing having an outer surface and an inner surface that defines an interior volume of the housing, a microphone disposed within the interior volume of the housing and including an inlet, and an acoustic path disposed at least partially within the interior volume of the housing. The acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a first opening defined by the outer surface of the housing; and a second acoustic port disposed at the second end of the conduit and acoustically coupled to a second opening defined by the outer surface of the housing. The acoustic path further includes an outlet connected to the middle section of the conduit, where the outlet acoustically couples the acoustic path to the inlet of the microphone. A portion of at least one of the first section or middle section of the conduit includes a cross-sectional area in a cross-sectional plane that is orthogonal to the conduit axis that decreases in a direction from the first end of the conduit to the outlet along the conduit axis.

Example Ex2. The device of Ex1, where a portion of at least one of the second section or middle section of the conduit includes a cross-sectional area in the cross-sectional plane that decreases in a direction from the second end of the conduit to the outlet along the conduit axis.

Example Ex3. The device of any one of Ex1-Ex2, where the middle section of the conduit includes a venturi that is centered at the outlet.

Example Ex4. The device of any one of Ex1-Ex3, where the first section of the conduit includes a substantially constant cross-sectional area along the conduit axis.

Example Ex5. The device of any one of Ex1-Ex4, where the second section of the conduit includes a substantially constant cross-sectional area along the conduit axis.

Example Ex6. The device of any one of Ex1-Ex5, where the conduit includes a top surface and a bottom surface, where the outlet of the acoustic path is connected to the bottom surface.

Example Ex7. The device of Ex6, where a length of the conduit is measured along the conduit axis, wherein a width of the conduit is measured along a first transverse axis that is orthogonal to the conduit axis and forms a plane with the conduit axis that is parallel to a portion of the top surface in the first section of the conduit at the first end of the conduit, and where a height of the conduit is measured along a second transverse axis that is orthogonal to the conduit axis and the first transverse axis.

Example Ex8. The device of Ex7, where a width of the middle section of the conduit decreases in the direction from the first end of the conduit to the outlet of the acoustic path.

Example Ex9. The device of any one of Ex7-Ex8, where a height of the middle section of the conduit decreases in the direction from the first end of the conduit to the outlet of the acoustic path.

Example Ex10. The device of any one of Ex7-Ex8, where the conduit axis is curved in the plane defined by the conduit axis and the first transverse axis.

Example Ex11. The device of any one of Ex1-Ex10, where a smallest cross-sectional area of the middle section of the conduit is no greater than one half of a greatest cross-sectional area of the first section of the conduit at the first end of the conduit.

Example Ex12. The device of any one of Ex1-Ex11, where a smallest cross-sectional area of the middle section of the conduit is no greater than one half a greatest cross-sectional area of the second section of the conduit at the second end of the conduit.

Example Ex13. The device of any one of Ex1-Ex12, where a cross-sectional area of at least one of the first section or second section of the conduit is no greater than 0.8 mm\hat{ }2.

Example Ex14. The device of any one of Ex1-Ex13, where a cross-sectional area of the middle section of the conduit is no greater than 0.25 mm\hat{ }2.

Example Ex15. The device of any one of Ex1-Ex14, where the acoustic path defines a broadband wind noise filter configured to reduce wind noise in acoustic energy received by the microphone by at least 2 dB.

Example Ex16. The device of any one of Ex1-Ex15, further including an acoustic filter disposed at least partially within the interior volume of the housing and including a neck and a resonance cavity acoustically coupled to the neck. The acoustic filter is acoustically coupled to the acoustic path via the neck, and the cavity of the acoustic filter has a resonant frequency in a selected frequency range.

Example Ex17. The device of Ex16, where the selected frequency range includes frequencies of at least about 20 kHz and no greater than about 50 kHz.

Example Ex18. The device of any one of Ex1-Ex17, where an inner surface of the conduit includes a curved portion.

Example Ex19. The device of Ex18, where the curved portion defines a transition region of the conduit between the first section and the middle section.

Example Ex20. The device of any one of Ex1-Ex19, where the microphone defines a first microphone and the acoustic path defines a first acoustic path. The device further includes a second microphone disposed within the interior volume of the housing and including an inlet, and a second acoustic path disposed at least partially within the interior volume of the housing. The second acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a third opening defined by the outer surface of the housing; and a second acoustic port disposed at the second end of the conduit and acoustically coupled to a fourth opening defined by the outer surface of the housing. The second acoustic path further includes an outlet connected to the middle section of the conduit, where the outlet acoustically couples the second acoustic path to the inlet of the second microphone. A portion of the at least one of the first section or middle section of the conduit includes a cross-sectional area in a cross-sectional plane that is orthogonal to the conduit axis that decreases in a direction from the first end of the conduit to the outlet along the conduit axis.

Example Ex21. The device of Ex20, where a portion of at least one of the second section or middle section of the conduit of the second acoustic path includes a cross-sectional area in the cross-sectional plane that decreases in a direction from the second end of the conduit to the outlet along the conduit axis.

Example Ex22. The device of any one of Ex20-Ex21, further including a second acoustic filter disposed at least partially within the interior volume of the housing and including a neck and a resonance cavity acoustically coupled to the neck. The second acoustic filter is acoustically coupled to the second acoustic path via the neck. Further, the cavity of the second acoustic filter has a resonant frequency in a selected frequency range.

Example Ex23. The device of any one of Ex1-Ex22, further including an earpiece that is coupled to the housing by a cable, where the earpiece includes an earpiece housing and a receiver disposed at least partially within the earpiece housing. The receiver is configured to direct acoustic waves into a wearer's ear through a receiver path that extends between an outlet disposed at an outer surface of the earpiece housing and an inlet disposed within the earpiece housing that is acoustically coupled to the receiver.

Example Ex24. An acoustic path configured to be disposed at least partially within an interior volume of a housing of an ear-wearable device. The acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a first opening defined by an outer surface of the housing; and a second acoustic port disposed at the second end of the conduit and acoustically coupled to a second opening defined by the outer surface of the housing. The acoustic path further includes an outlet connected to the middle section of the conduit, where the outlet is configured to acoustically couple the acoustic path to an inlet of a microphone that is disposed within the interior volume of the housing of the device. A portion of the at least one of the first section or middle section of the conduit includes a cross-sectional area in a cross-sectional plane that is orthogonal to the conduit axis that decreases in a direction from the first end of the conduit to the outlet along the conduit axis.

Example Ex25. The acoustic path of Ex24, where a portion of at least one of the second section or middle section of the conduit includes a cross-sectional area in the cross-sectional plane that decreases in a direction from the second end of the conduit to the outlet along the conduit axis.

Example Ex26. The acoustic path of any one of Ex24-Ex25, where the middle section of the conduit includes a venturi that is centered at the outlet.

Example Ex27. The acoustic path of any one of Ex24-Ex26, where the first section of the conduit includes a substantially constant cross-sectional area along the conduit axis.

Example Ex28. The acoustic path of any one of Ex24-Ex27, where the second section of the conduit includes a substantially constant cross-sectional area along the conduit axis.

Example Ex29. The acoustic path of any one of Ex24-Ex27, where the conduit includes a top surface and a bottom surface, where the outlet of the acoustic path is connected to the bottom surface.

Example Ex30. The acoustic path of Ex29, where a length of the conduit is measured along the conduit axis, wherein a width of the conduit is measured along a first transverse axis that is orthogonal to the conduit axis and forms a plane with the conduit axis that is parallel to a portion of the top surface in the first section of the conduit at the first end of the conduit, and where a height of the conduit is measured along a second transverse axis that is orthogonal to the conduit axis and the first transverse axis.

Example Ex31. The acoustic path of Ex30, where a width of the middle section of the conduit decreases in the direction from the first end of the conduit to the outlet of the acoustic path.

Example Ex32. The acoustic path of any one of Ex30-Ex31, where a height of the middle section of the conduit decreases in the direction from the first end of the conduit to the outlet of the acoustic path.

Example Ex33. The acoustic path of any one of Ex30-Ex32, where the conduit axis is curved in the plane defined by the conduit axis and the first transverse axis.

Example Ex34. The acoustic path of any one of Ex24-Ex33, where a smallest cross-sectional area of the middle section of the conduit is no greater than one half of a greatest cross-sectional area of the first section of the conduit.

Example 35. The acoustic path of any one of Ex24-Ex34, where a smallest cross-sectional area of the middle section of the conduit is no greater than one half a greatest cross-sectional area of the second section of the conduit at the second end of the conduit.

Example Ex36. The acoustic path of any one of Ex24-Ex35, where a cross-sectional area of at least one of the first section or the second section of the conduit is no greater than 0.8 mm\hat{ }2.

Example Ex37. The acoustic path of any one of Ex24-Ex36, where a cross-sectional area of the middle section of the conduit is no greater than 0.25 mm\hat{ }2.

Example Ex38. The acoustic path of any one of Ex24-Ex37, where the acoustic path defines a broadband wind noise filter configured to reduce wind noise in acoustic energy received by the microphone by at least 2 dB.

Example Ex39. The acoustic path of any one of Ex24-Ex38, further including an acoustic filter disposed at least partially within the interior volume of the housing and including a neck and a resonance cavity acoustically coupled to the neck, where the acoustic filter is acoustically coupled to the acoustic path via the neck, and further where the cavity of the acoustic filter has a resonant frequency in a selected frequency range.

Example Ex40. The acoustic path of Ex39, where the selected frequency range of the cavity includes frequencies of at least about 20 kHz and no greater than about 50 kHz.

Example Ex41. The acoustic path of any one of Ex24-Ex40, where an inner surface of the conduit includes a curved portion.

Example Ex42. The acoustic path of Ex41, where the curved portion defines a transition region of the conduit between the first section and the middle section.

Example Ex43. A method of forming an ear-wearable electronic device, including disposing a microphone within an interior volume of a housing of the ear-wearable electronic device, where the interior volume is defined by an inner surface of the housing; and disposing an acoustic path at least partially within the interior volume of the housing. The acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a first opening defined by an outer surface of the housing; and a second acoustic port disposed at the second end of the conduit and acoustically coupled to a second opening defined by the outer surface of the housing. The acoustic path further includes an outlet connected to the middle section of the conduit. A portion of at least one of the first section or middle section of the conduit includes a cross-sectional area in a cross-sectional plane that is orthogonal to the conduit axis that decreases in a direction from the first end of the conduit to the outlet along the conduit axis. The method further includes acoustically coupling the microphone to the acoustic path via the outlet of the acoustic path.

Example Ex44. The method of Ex43, further including disposing an acoustic filter at least partially within the interior volume of the housing, where the acoustic filter includes a neck and a resonance cavity acoustically coupled to the neck, where the acoustic filter is acoustically coupled to the acoustic path via the neck, and further where the cavity of the acoustic filter has a resonant frequency in a selected frequency range.

Example Ex45. The method of Ex44, where the microphone defines a first microphone and the acoustic path defines a first acoustic path. The method further includes disposing a second microphone within the interior volume of the housing and including an inlet, and disposing a second acoustic path at least partially within the interior volume of the housing. The second acoustic path includes a conduit extending along a conduit axis between a first end and a second end, where the conduit includes a first section at the first end, a second section at the second end, and a middle section disposed between the first section and the second section; a first acoustic port disposed at the first end of the conduit and acoustically coupled to a third opening defined by the outer surface of the housing; and a second acoustic port disposed at the second end of the conduit and acoustically coupled to a fourth opening defined by the outer surface of the housing. The acoustic path further includes an outlet connected to the middle section of the conduit. A portion of the at least one of the first section or middle section of the conduit includes a cross-sectional area in a cross-sectional plane that is orthogonal to the conduit axis that decreases in a direction from the first end of the conduit to the outlet along the conduit axis. The method further includes acoustically coupling the second microphone to the second acoustic path via the outlet of the second acoustic path.

Example Ex46. The method of Ex45, where the acoustic filter defines a first acoustic filter. The method further includes disposing a second acoustic filter at least partially within the interior volume of the housing, where the second acoustic filter includes a neck and a resonance cavity acoustically coupled to the neck. The second acoustic filter is acoustically coupled to the acoustic path via the neck. Further the cavity of the second acoustic filter has a resonant frequency in a second selected frequency range.

Example Ex47. The method of any one of Ex43-Ex46, further including coupling an earpiece to the housing via a cable, where the earpiece includes an earpiece housing and a receiver disposed at least partially within the earpiece housing; and directing acoustic waves into a wearer's ear through a receiver path that extends between an outlet disposed at an outer surface of the earpiece housing and an inlet disposed within the earpiece housing that is acoustically coupled to the receiver.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device comprising:
a housing comprising an outer surface and an inner surface that defines an interior volume of the housing;
a microphone disposed within the interior volume of the housing and comprising an inlet;
an acoustic path disposed at least partially within the interior volume of the housing and comprising:
a conduit extending along a conduit axis between a first end and a second end, wherein the conduit comprises a first section at the first end, a second section at the second end, and a middle section disposed between the first section and the second section;
a first acoustic port disposed at the first end of the conduit and acoustically coupled to a first opening defined by the outer surface of the housing;
a second acoustic port disposed at the second end of the conduit and acoustically coupled to a second opening defined by the outer surface of the housing; and
an outlet connected to the middle section of the conduit, wherein the outlet acoustically couples the acoustic path to the inlet of the microphone;
wherein a portion of at least one of the first section or middle section of the conduit comprises a cross-sectional area in a cross-sectional plane that is orthogonal to the conduit axis that decreases in a direction from the first end of the conduit to the outlet along the conduit axis.

2. The device of claim 1, wherein a portion of at least one of the second section or middle section of the conduit comprises a cross-sectional area in the cross-sectional plane that decreases in a direction from the second end of the conduit to the outlet along the conduit axis.

3. The device of claim 1, wherein each of the first section and the second section of the conduit comprises a substantially constant cross-sectional area along the conduit axis.

4. The device of claim 1, wherein:
the conduit comprises a top surface and a bottom surface;
the outlet of the acoustic path is connected to the bottom surface;
a length of the conduit is measured along the conduit axis;
a width of the conduit is measured along a first transverse axis that is orthogonal to the conduit axis and forms a plane with the conduit axis that is parallel to a portion of the top surface in the first section of the conduit at the first end of the conduit; and
a height of the conduit is measured along a second transverse axis that is orthogonal to the conduit axis and the first transverse axis.

5. The device of claim 4, wherein a width of the middle section of the conduit decreases in the direction from the first end of the conduit to the outlet of the acoustic path.

6. The device of claim 4, wherein a height of the middle section of the conduit decreases in the direction from the first end of the conduit to the outlet of the acoustic path.

7. The device of claim 1, wherein a smallest cross-sectional area of the middle section of the conduit is no greater than one half of a greatest cross-sectional area of the first section of the conduit at the first end of the conduit.

8. The device of claim 1, wherein the acoustic path defines a broadband wind noise filter configured to reduce wind noise in acoustic energy received by the microphone by at least 2 dB.

9. The device of claim 1, further comprising an acoustic filter disposed at least partially within the interior volume of the housing and comprising a neck and a resonance cavity acoustically coupled to the neck, wherein the acoustic filter is acoustically coupled to the acoustic path via the neck, and further wherein the cavity of the acoustic filter has a resonant frequency in a selected frequency range.

10. The device of claim 1, wherein an inner surface of the conduit comprises a curved portion.

11. An acoustic path configured to be disposed at least partially within an interior volume of a housing of an ear-wearable device, the acoustic path comprising:
a conduit extending along a conduit axis between a first end and a second end, wherein the conduit comprises a first section at the first end, a second section at the second end, and a middle section disposed between the first section and the second section;
a first acoustic port disposed at the first end of the conduit and acoustically coupled to a first opening defined by an outer surface of the housing;
a second acoustic port disposed at the second end of the conduit and acoustically coupled to a second opening defined by the outer surface of the housing; and
an outlet connected to the middle section of the conduit, wherein the outlet is configured to acoustically couple the acoustic path to an inlet of a microphone that is disposed within the interior volume of the housing of the device;
wherein a portion of the at least one of the first section or middle section of the conduit comprises a cross-sectional area in a cross-sectional plane that is orthogonal to the conduit axis that decreases in a direction from the first end of the conduit to the outlet along the conduit axis.

12. The acoustic path of claim 11, wherein a portion of at least one of the second section or middle section of the conduit comprises a cross-sectional area in the cross-sectional plane that decreases in a direction from the second end of the conduit to the outlet along the conduit axis.

13. The acoustic path of claim 11, wherein each of the first section and the second section of the conduit comprises a substantially constant cross-sectional area along the conduit axis.

14. The acoustic path of claim 11, wherein:
the conduit comprises a top surface and a bottom surface, wherein the outlet of the acoustic path is connected to the bottom surface;
a length of the conduit is measured along the conduit axis;
a width of the conduit is measured along a first transverse axis that is orthogonal to the conduit axis and forms a plane with the conduit axis that is parallel to a portion of the top surface in the first section of the conduit at the first end of the conduit; and
a height of the conduit is measured along a second transverse axis that is orthogonal to the conduit axis and the first transverse axis.

15. The acoustic path of claim 11, wherein the acoustic path defines a broadband wind noise filter configured to reduce wind noise in acoustic energy received by the microphone by at least 2 dB.

16. The acoustic path of claim 11, further comprising an acoustic filter disposed at least partially within the interior volume of the housing and comprising a neck and a resonance cavity acoustically coupled to the neck,, wherein the acoustic filter is acoustically coupled to the acoustic path via the neck, and further wherein the cavity of the acoustic filter has a resonant frequency in a selected frequency range.

17. A method of forming an ear-wearable electronic device, comprising:
disposing a microphone within an interior volume of a housing of the ear-wearable electronic device, wherein the interior volume is defined by an inner surface of the housing;
disposing an acoustic path at least partially within the interior volume of the housing, wherein the acoustic path comprises:
a conduit extending along a conduit axis between a first end and a second end, wherein the conduit comprises a first section at the first end, a second section at the second end, and a middle section disposed between the first section and the second section;
a first acoustic port disposed at the first end of the conduit and acoustically coupled to a first opening defined by an outer surface of the housing;
a second acoustic port disposed at the second end of the conduit and acoustically coupled to a second opening defined by the outer surface of the housing; and
an outlet connected to the middle section of the conduit;
wherein a portion of at least one of the first section or middle section of the conduit comprises a cross-sectional area in a cross-sectional plane that is orthogonal to the conduit axis that decreases in a direction from the first end of the conduit to the outlet along the conduit axis; and
acoustically coupling the microphone to the acoustic path via the outlet of the acoustic path.

18. The method of claim 17, further comprising disposing an acoustic filter at least partially within the interior volume of the housing, wherein the acoustic filter comprises a neck and a resonance cavity acoustically coupled to the neck, wherein the acoustic filter is acoustically coupled to the acoustic path via the neck, and further wherein the cavity of the acoustic filter has a resonant frequency in a selected frequency range.

19. The method of claim 18, wherein the microphone defines a first microphone and the acoustic path defines a first acoustic path, wherein the method further comprises:
disposing a second microphone within the interior volume of the housing and comprising an inlet; and
disposing a second acoustic path at least partially within the interior volume of the housing, wherein the second acoustic path comprises:
a conduit extending along a conduit axis between a first end and a second end, wherein the conduit comprises a first section at the first end, a second section at the second end, and a middle section disposed between the first section and the second section;
a first acoustic port disposed at the first end of the conduit and acoustically coupled to a third opening defined by the outer surface of the housing;
a second acoustic port disposed at the second end of the conduit and acoustically coupled to a fourth opening defined by the outer surface of the housing; and
an outlet connected to the middle section of the conduit;
wherein a portion of the at least one of the first section or middle section of the conduit comprises a cross-sectional area in a cross-sectional plane that is orthogonal to the conduit axis that decreases in a direction from the first end of the conduit to the outlet along the conduit axis; and
acoustically coupling the second microphone to the second acoustic path via the outlet of the second acoustic path.

20. The method of claim 19, wherein the acoustic filter defines a first acoustic filter, wherein the method further comprises disposing a second acoustic filter at least partially within the interior volume of the housing, wherein the second acoustic filter comprises a neck and a resonance cavity acoustically coupled to the neck, wherein the second acoustic filter is acoustically coupled to the acoustic path via the neck, and further wherein the cavity of the second acoustic filter has a resonant frequency in the selected frequency range.
